(19) United States
(12) Patent Application Publication
(10) Pub. No.: US 2011/0094980 A1
(43) Pub. Date: Apr. 28, 2011

(54) DISPLAY CHANNEL APPARATUS

(76) Inventors: Serge L. Cousin, Spring Lake, MI (US); Robert A. Claeys, Grand Haven, MI (US)

(21) Appl. No.: 12/767,435

(22) Filed: Apr. 26, 2010

Related U.S. Application Data
(60) Provisional application No. 61/254,381, filed on Oct. 23, 2009.

(51) Int. Cl. A47F 7/00; B23P 11/00

(52) U.S. Cl. 211/59.2; 29/525

(57) ABSTRACT

A display channel apparatus for displaying containers comprises a starter channel, a plurality of extender channels, fronts and rears. These components include a plurality of horizontally-engaging mating connectors that are preferably integrally formed, and formed without slides or pulls in the plastic molding dies, and further that have sufficient length and stiffness to provide a stable assembly after interconnection. They also facilitate quick assembly by sliding engagement on a table top. In one form, the components are laterally compressible/extendable to a selected width for receiving a particular sized product, and clips or connectors are adapted to fix the selected width. The individual components and the assembled components mate together for densely-stacked compact arrangements for storage (unassembled or assembled) and/or shipping. Also, the components can be selectively assembled to meet individual needs and preferences, as well as broken down for reuse, refurbishing, and/or recycling.

This claims benefit under 35 U.S.C. §119(e) of provisional application Ser. No. 61/254/381, filed Oct. 23, 2009, entitled DISPLAY CHANNEL APPARATUS, the entire contents of which are incorporated herein in their entirety.

### BACKGROUND

The present invention relates to a display channel apparatus which can be readily assembled to form a multi-channel display rack, and more particularly to such a display rack apparatus having an unusual configuration, including flexibility of assembly, low cost, and communized basic individual components that facilitate dense packaging for storage, transport, and shipping (before assembly, after partial assembly and/or after full assembly).

Presently known display channel apparatus include expensive subcomponents, expensive tooling required to form the same, and difficult and/or cumbersome manual assembly. Further, the components and related assemblies have a poor storage and shipping density, are cumbersome to handle and ship, and are often overly complex and not intuitive to assemble. Further known apparatus waste shelf space, are inflexible to use, and are often difficult or impossible to fix, refurbish, or recycle. Still further, a design is desired that provides a greater amount of flexible use, adjustable assembly, and that is able to satisfy a wide variety of different store/user needs.

### SUMMARY OF THE PRESENT INVENTION

In one aspect of the present invention, a display channel apparatus for slidingly supporting rows of individual containers for purchase from a front of each row, comprises an elongated starter channel component, and a plurality of elongated extender channel components each including horizontally-oriented connectors constructed for quick-connect in a horizontal direction to a side of a selected one of the starter channel and the extender channels, and that when connected, define multiple parallel channels each of desired width generally matching a width dimension of the individual containers. The apparatus further includes plurality of front components configured for attachment to a front of one or both of the starter channel and extender channels.

In another aspect of the present invention, a display channel apparatus for slidingly supporting rows of individual containers for purchase from a front of each row, the individual containers defining at least first and second different widths dimensions, comprises a plurality of channel-forming components including mating connectors that can be interlockingly connected to position and secure the channel-forming components adjacently, at least one of the connectors and the channel-forming components being adjustable to define at least the first and second different width dimensions.

In another aspect of the present invention, a display channel apparatus for containers, comprises a wall-defining starter component, and a plurality of L-shaped channel components interconnected to each other and to the wall-defining component to form a plurality of parallel paths, the parallel paths each sharing a common wall provided by one of the starter component and the L-shaped channel components.

In another aspect of the present invention, an apparatus for supporting sliding rows of individual containers for purchase from a front of each row, comprises an adjustable-width floor component, a plurality of vertical-wall-forming components attached to the floor component at selected parallel spaces to define a plurality of upwardly-open parallel channels thereon, and a plurality of width-fixing components fixing the adjustable-width floor component to a desired adjusted width for each of the channels, so that the channels each match a width of the selected individual containers in each row.

In another aspect of the present invention, a method of assembling a display channel apparatus for containers includes steps of providing a plurality of channel-forming components including integrally-formed mating connectors, and interlockingly assembling the channel-forming components by placing the components on a horizontal surface and sliding the elements horizontally to engage mating connectors.

In another aspect of the present invention, a display channel apparatus for containers includes a U-shaped channel forming a first path for containers including a front for presenting a front one of the containers, and a plurality of L-shaped channels attached to the U-shaped channel and to each other to form additional paths extending parallel and adjacent the first path. An inner wall of the U-shaped channel also forms a wall of the path in an adjacent one of the L-shaped channels, and a wall of each of the L-shaped channels also forms a wall of the path in an adjacent one of the L-shaped channels.

In another aspect of the present invention, a display channel apparatus for containers comprises a starter channel, a plurality of extender channels, and a plurality of fronts. The starter channel and extender channels include a plurality of first male connectors and a plurality of first female connectors for mating horizontal connection. The extender channels also include a plurality of the first female connectors for mating horizontal connection to adjacent extender channels. The starter channel and the fronts include a second male connector and a second female connector for mating horizontal connection. The extender channels and the fronts also include a second male connector for mating horizontal connection to the fronts.

In a narrower aspect of the present invention, the first and second male connectors are a same shape.

In a narrower aspect of the present invention, a plurality of rear ends are provided with connectors for mating attachment to one of the starter and extender channels.

In another aspect of the present invention, a display channel apparatus for containers comprises a plurality of channel-forming components including integrally-formed mating connectors that can be interlockingly assembled to position the channel-forming components adjacently, and which are removable so that a last one of the channel-forming components does not include outwardly-extending ones of the connectors.

In another aspect of the present invention, a display channel apparatus for containers comprises a plurality of channel-forming components including horizontally-facing mating connectors that can support horizontal interlocking assembly of the channel-forming components, and which are removable so that a last one of the channel-forming components does not include outwardly-extending ones of the connectors.

In another aspect of the present invention, a display channel apparatus for containers, comprises a plurality of channel-forming components designed for interlocking assembly to form parallel paths for dispensing containers, the plurality of channel-forming components being shaped to be inverted and interfit together to increase ship density by at least 40%.

In a narrower aspect of the present invention, the channel-forming components can be interfit prior to being assembled together to form a multi-channel apparatus and to increase a ship density by at least 70%.

In another aspect of the present invention, a display channel apparatus for containers comprises a plurality of channel-forming components designed for interlocking assembly to form parallel paths for dispensing containers, the plurality of channel-forming components being shaped to be interfit together to increase ship density by at least 70% prior to assembly.

In another aspect of the present invention, a method of assembling a display channel apparatus for containers comprises steps of providing a plurality of channel-forming components including integrally-formed mating connectors, and interlockingly assembling the channel-forming components by friction attachment to define channels of selected widths.

In another aspect of the present invention, a method of assembling a display channel apparatus for containers comprises steps of providing a plurality of channel-forming components including integrally-formed mating connectors, and interlockingly assembling the channel-forming components by placing the components on a horizontal table surface and sliding the components horizontally to engage mating connectors.

In another aspect of the present invention, a display channel apparatus for containers comprises a plurality of channel-forming components including mating connectors that can be interlockingly assembled to position the channel-forming elements adjacently, the connectors being adjustable to fix a width of paths formed by the adjacent channel-forming components.

In another aspect of the present invention, a display channel apparatus for containers comprises a wall-defining starter component, and a plurality of L-shaped channel components interconnected to each other and to the wall-defining element to form a plurality of parallel paths, the parallel paths each sharing a common wall provided by one of the L-shaped channel components.

In another aspect of the present invention, a display channel apparatus includes a floor component constructed to slidably support containers and having first connectors at multiple locations, and including a plurality of vertical wall-forming components with second connectors attached to selected ones of the first connectors to define a plurality of parallel rows for slidably supporting product thereon, the rows having selected width dimensions.

An object of the present invention is to provide a display channel apparatus that can be assembled in a side-ways horizontal direction to form a multi-channel display apparatus, the components providing flexibility of assembly, low cost of parts and labor, and use of communized basic individual components that facilitate dense packaging for storage, transport, and shipping (prior to or after partial assembly or full assembly).

An object of the present invention is to provide an assembly having an adjustable width where channel width can be selectively set and fixed during assembly.

These and other aspects, objects, and features of the present invention will be understood and appreciated by those skilled in the art upon studying the following specification, claims, and appended drawings.

### BRIEF DESCRIPTION OF DRAWINGS

FIG. 1 is a perspective view of an assembled display apparatus embodying the present invention resting on a refrigerator/cooler shelf, and

FIG. 2 is a side view of same.

FIG. 3 is an enlarged view of the circled area III in FIG. 2.

FIGS. 4-5 are front and rear bottom exploded perspective views of a U-shaped channel component, an L-shaped component for mating snap connection, and a snap-attach front component.

FIG. 6 is a bottom exploded perspective view of a U-shaped channel component and an L-shaped component for adjustable interconnection.

FIGS. 7-8 are bottom perspective views of modified front components of that shown in FIGS. 4-5.

FIG. 9 is a bottom perspective view, partially exploded, showing multiple L-shaped components attached to a primary channel component along with two front components and one rear component.

FIG. 10 is a bottom view of FIG. 9.

FIG. 11 is a perspective view of a channel component similar to FIGS. 4-5, but the vertical walls including vertical V-groove indentations (see FIG. 12, taken along the cross section XII in FIG. 11) so that the channel component can be broken off without separate tools to become a different length (see FIG. 13, with broken-off end piece).

FIG. 14 is a perspective view of an L-shaped component having vertical V-groove indentations like that shown in FIG. 11, and

FIG. 15 is an L-shaped component with broken-off end piece.

FIG. 16 is a perspective view showing an upside-down assembly interfit onto a right-side-up assembly;

FIG. 17 showing the two assemblies prior to being interfit and

FIG. 18 showing the assemblies after being interfit for dense shipping.

FIG. 19 is an end view showing upside-down channel components interfit onto right-side-up channel components for dense shipment prior to assembly; and

FIG. 20 is an end view similar to FIG. 19 but showing L-shaped components.

FIG. 21 is a perspective view showing two display channel apparatus positioned on vertically spaced wire shelves in a commercial cooler for dispensing soda or drinks.

FIG. 22 is a perspective view of the display channel apparatus of FIG. 21.

FIG. 23 is an end view of an adjustable-width channel component and an adjustable-width L-shaped component prior to adjustment.

FIG. 24 is an end view of the components of FIG. 23 after locking an adjusted width; and

FIG. 25 is an assembly of the components of FIG. 24.

FIG. 26 is a perspective view of an adjustable-width L-shaped component;

FIG. 27 is a top view of the component after attaching a width-fixing strip component, and

FIG. 28 is a perspective view of the width-fixing component.

FIG. 29 is an exploded perspective view of an alternative adjustable-width channel component and L-shaped component with width-fixing strip component.

FIG. 30 is an exploded perspective of another adjustable-width system including an adjustable-width floor, wall-forming components that snap into the floor, and connectors that fix a selected width.

FIG. 31 is a perspective view of an enlarged portion of FIG. 30.

FIG. 32 is a perspective view of an alternative adjustable-width channel display apparatus.

FIG. 33 is an enlarged perspective view of a corner of FIG. 32, and

FIG. 34 is an exploded view of same.

FIGS. 35-36 are side and end views of FIG. 32, and

FIG. 37 is an enlarged view of a portion of FIG. 32.

### DETAILED DESCRIPTION OF PREFERRED EMBODIMENTS

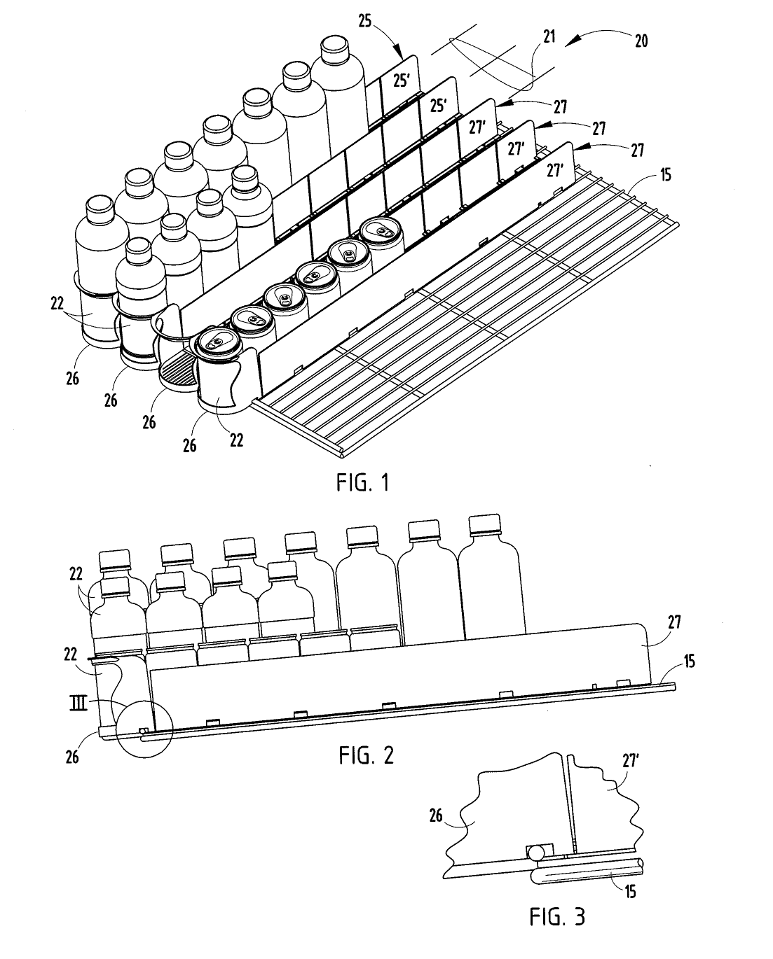

The present display channel apparatus 20 (FIG. 1) for shelves 15 of a commercial refrigeration unit (see unit 14A in FIG. 21) provides multiple parallel channels/paths 21 for containers 22 to slide forward, thus allowing singular selection from a front of the apparatus 20. The illustrated apparatus 20 (FIG. 1) is made of polymeric components configured to horizontally snap assemble, and in particular includes a U-shaped channel component 25 (also called “starter channels”) forming a first path 21 for the containers, a front component 26 (also called “front”) attached to the channel 25 for providing a front stop where a container can be selected from a front of the path 21. A plurality of L-shaped channel components 27 (also called “extender channels”) are attached to sides of the U-shaped channel 25, each including a front 26, and are attached to each other to form additional paths extending parallel and adjacent the first path. A rear component 28 is also attached to define a rear stop on each path. The assembled apparatus 20 can be placed on a shelf in a refrigeration unit in a convenience store for dispensing pop and drink containers. Notably, the present components can be made with recycled plastics, thus making this system environmentally friendly and “green.” Further, the assembly can be broken down into individual components, thus making the present system even more environmentally friendly and “green” even where specific (different) plastics were selected for their specific functional requirements (such as different plastics for the front and/or for the channels).

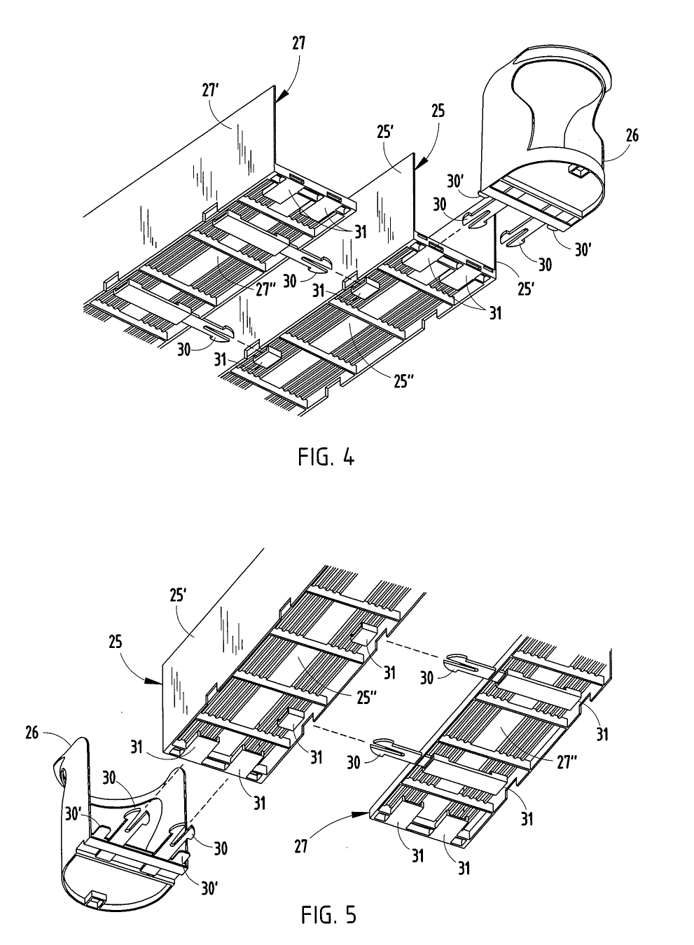

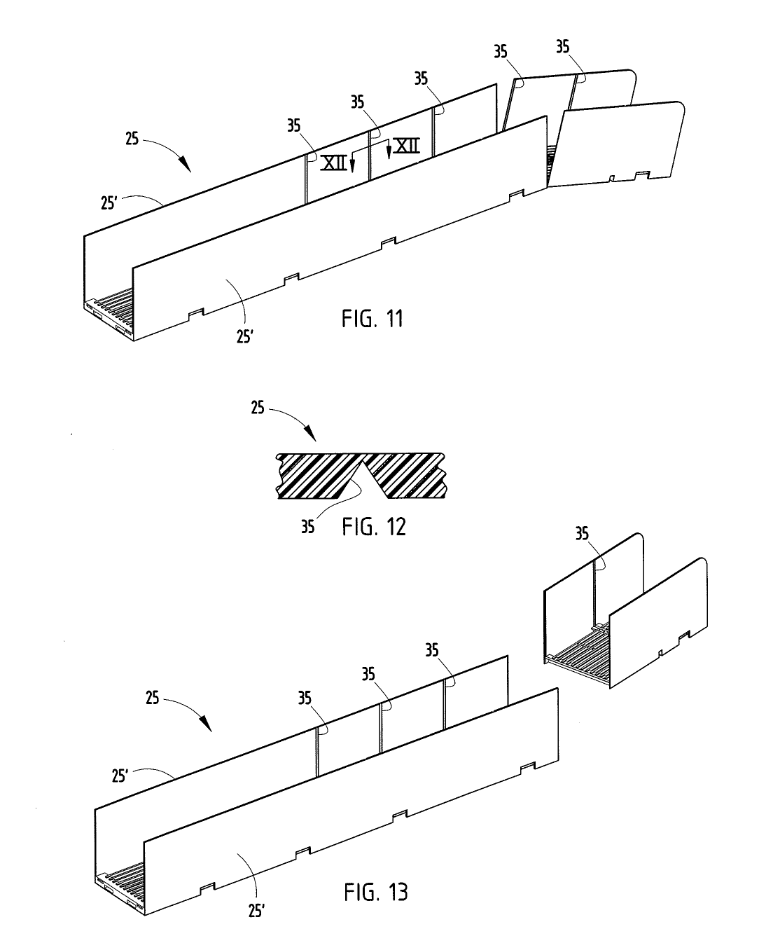

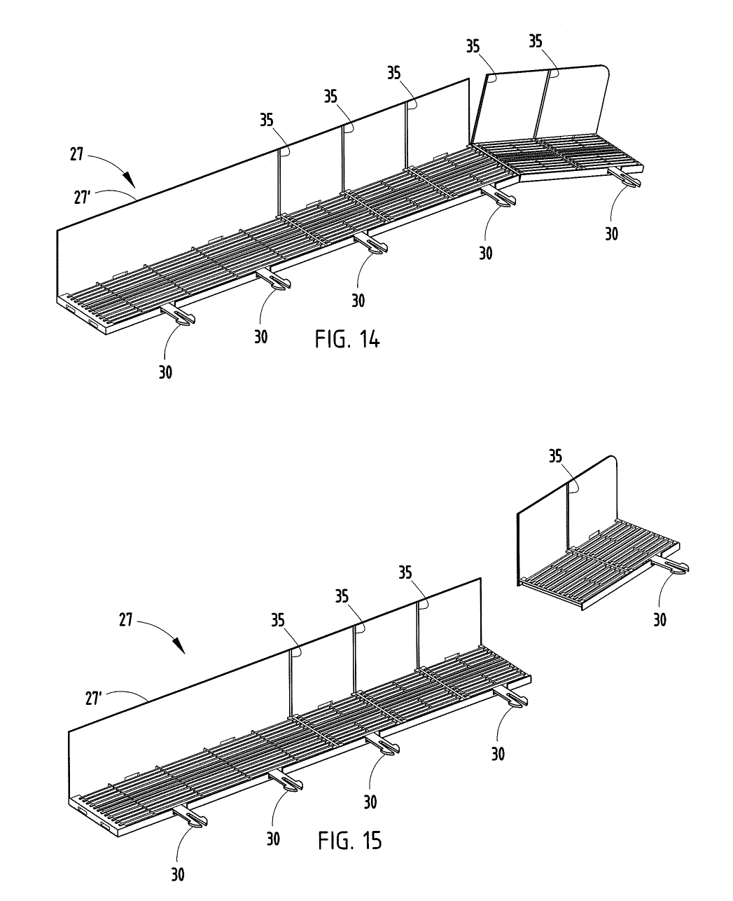

The U-channel 25 (FIGS. 3-4, bottom views) includes two walls 25′ and a floor 25″, with an innermost one of the walls 25′ of the U-shaped channel 25 also forming a common wall for the path in an adjacent one of the L-shaped channels 27. The L-shaped channels 27 include a vertical wall 27′ and a horizontal floor 27″, with each vertical wall 27′ of each of the L-shaped channels 27 also forming a common wall of the path in an adjacent one of the L-shaped channels 27. Notably, the U-channel 25 and L-channels 27 can include thinned areas 35 (FIGS. 11-13) along their walls, such that they can be fractured and separated by manual flexing and/or with the assistance of a sharp tool) in order to shorten a length of the channels to a desired dimension.

The U-channel 25 (FIG. 1) is referred to herein as a starter channel, since it “starts” or “begins” a first one path in the plurality of channels/paths in an assembled apparatus. The L-channels 27 can also be referred to as extender components or extender elements since they “extend” or “add” additional parallel channels/paths to the apparatus as it is attached. Notably, it is contemplated that a selected number of L-channels 27 can be attached to form as many (or as few) channels/paths as a user desired. Further, since each channel includes at least one common wall, considerable space is saved since double-thick walls are avoided, and also since a maximum of space is retained for forming channels (instead of for forming walls that are thicker than they need to be). This is considered to be a great benefit by purchasers of these systems.

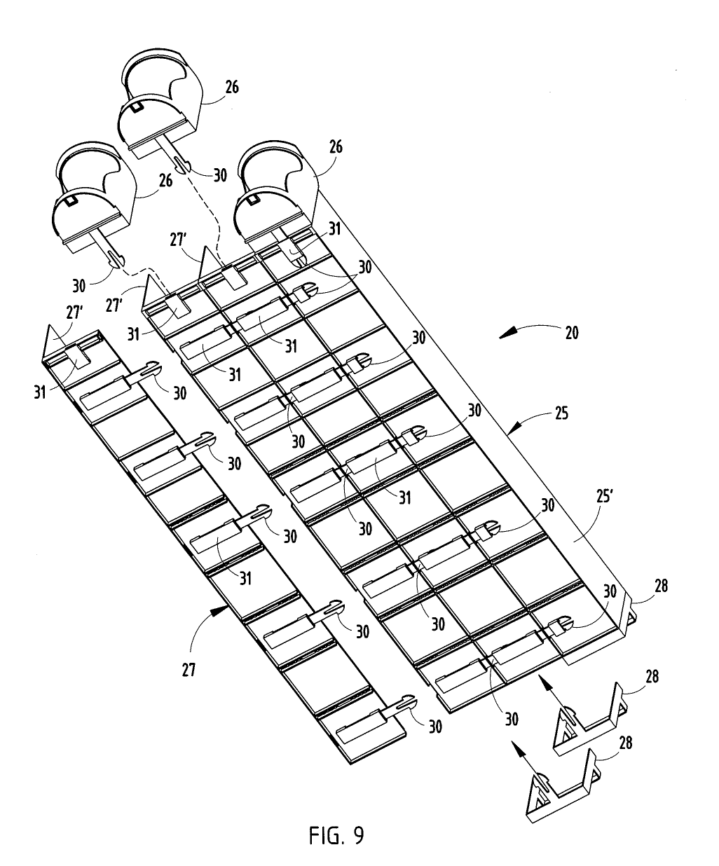

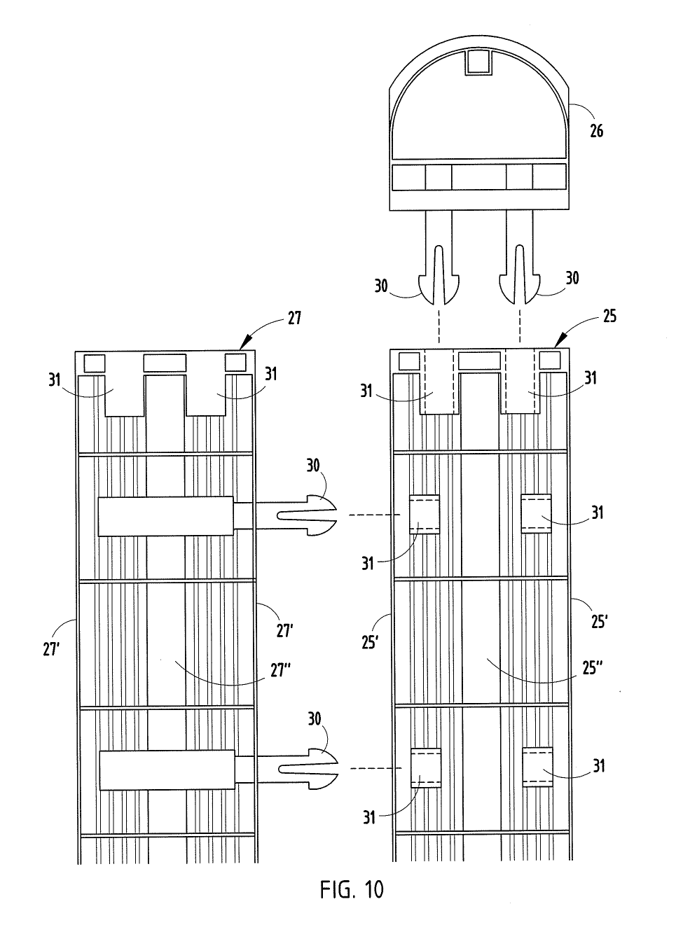

The illustrated apparatus 20 (FIG. 9) includes a plurality of individual fronts 26 and rears 28 that snap onto a front end and a rear end of each channel on each defined path. The illustrated front 26 and rear 28 are tall and short, respectively. However, it is contemplated that a variety of different heights, shapes and configurations can be provided. For example, front 26 (FIGS. 4-5,7) include a pair of connectors 30 and a pair of flat guide tabs 30′. FIG. 8 illustrates a modified front 26′ having a single connector 30 and a pair of side-positioned guide tabs 30″ that have a down-hooked end shaped to slip into mating vertically-open pockets in the end of the channel component 27. The rears 28 can be similarly modified. Alternatively, some purchasers of this equipment prefer to leave the rear end open, and hence they do not attach any rear component.

The starter channel 25, extender channels 27, fronts 26 and rears 28 (FIG. 4-8) include integrally-formed first male connectors 30 and a plurality of integrally-formed first female connectors 31 that are shaped and located for mating horizontal connection. The illustrated connectors 30 and 31 are identical, but it is contemplated that different mating connectors can be used if desired. The illustrated connectors 30 and 31 are configured to be formed without the need for slides and pulls on the molding dies, and further are elongated and stiff so that they provide sufficient torsional stiffness and lateral strength to provide an assembly that can be handled in the field. The illustrated connectors 30 and 31 are configured to slide together horizontally and snappingly engage, such that they can be placed on a table top and slid together for assembly, thus greatly assisting and facilitating quick, efficient, and intuitive assembly. The connectors 30 and 31 include stems with vertical beam-like flanges providing structure for strength, length for guided engagement, and longitudinal flexibility for resilient snap attachment. Notably, the flanges provide a location where the connectors 30 or 31 can be removed, such as by snapping or cutting them off (or by bending back and forth until they break), thus allowing connectors on a last one of the channels 27 to be removed so that they do not extend outboard of the assembly, and so that they do not take up (and waste) space within a refrigerator unit in a convenience store.

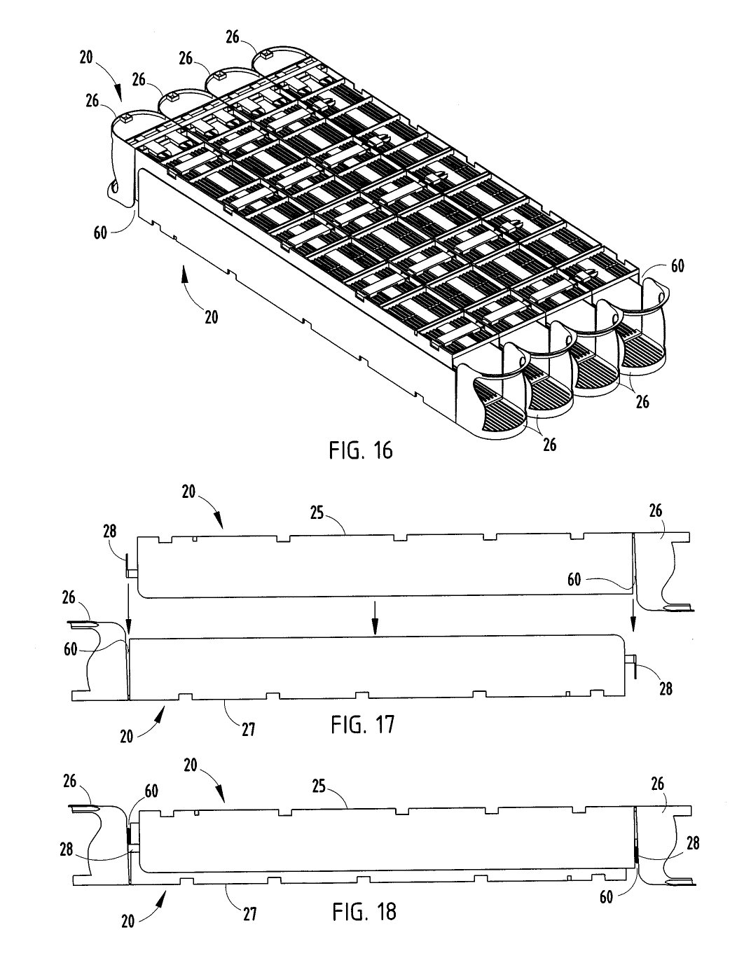

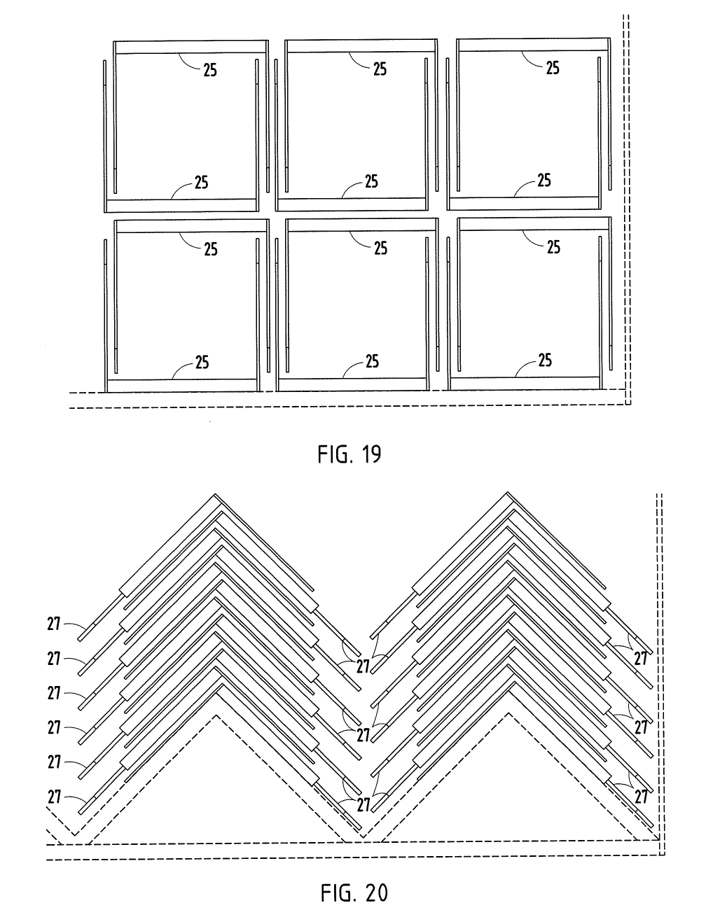

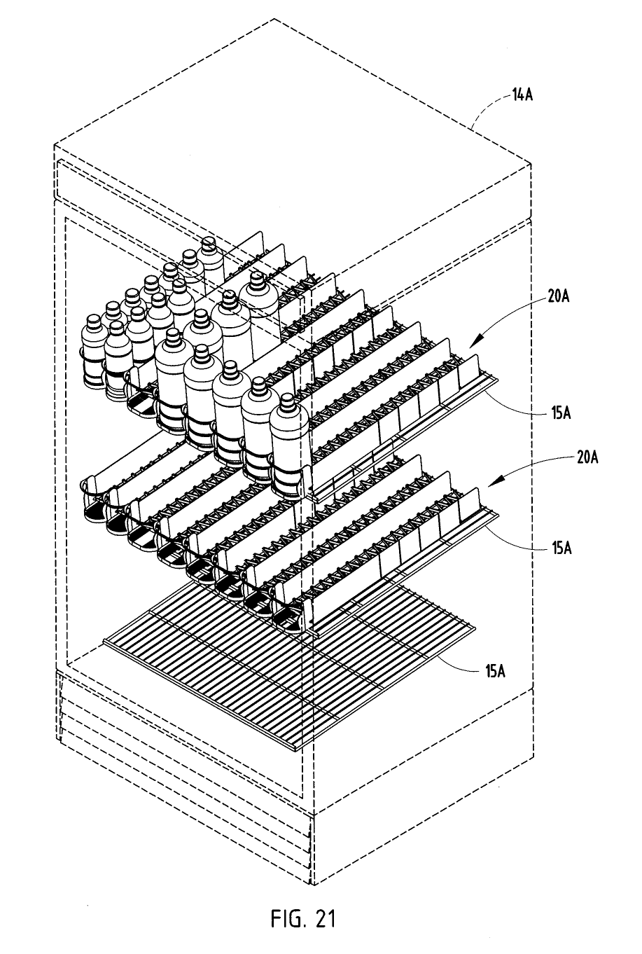

The illustrated assembled apparatus 20 can be inverted and interfit against another similar apparatus 20 either after assembly (see FIGS. 16-18) or prior to assembly (see FIGS. 19-20.) In particular, the assembled apparatus 20 (FIGS. 16-18) which includes vertical open slits at location 60 adapted to receive walls of a rear 28 in an opposing inverted interfit apparatus 20. By this arrangement, twice as many assembled apparatus 20 can be shipped. This double density is a tremendous advantage given the expense of shipment and given the expense of storing apparatus 20 prior to use. The increased density is at least about 40%, but can be as much as almost 50%, depending on the number of cardboard spacers, pallets, and shipping aids that are used.

The illustrated components 25-28 (FIGS. 19-20) also can be (prior to assembly) interfit together to increase ship density by at least 40%, and even as much as 70% and as illustrated by as much as 85% or more percent.

It is contemplated that all components can be designed so that they (including integral connectors) are made with molding dies that do not include pulls or draws or die components that move transversely to a die draw direction. For example, the illustrated channels 25 have a floor thickness formed by top and bottom flanges and vertical stiffening/connecting ribs. Where a connector is formed, there are openings in the top flanges and bottom flanges for allowing die steel through to form the connectors 30 and 31. Alternatively, it is contemplated that the female connectors can be integrally formed, and a male connector separately molded and snapped in place on a channel 25 or 27. It is noted that the floor includes a plurality of parallel ribs having sufficient vertical dimension to provide the sliding support to bottles and drinks placed thereon. (See FIGS. 1-2 and 21.)

An advantage of the present system is that the plurality of channel-forming elements (whether U-shaped, L-shaped, or single wall shaped or I-shaped) can be placed on a table and slidingly interlockingly assembled by horizontally-engaging mating connectors 30-31. This greatly facilitates assembly, since the illustrated individual molded components can have considerable flex when picked up, thus making it difficult to align the multiple connectors 30 and 31 on adjacent parts.

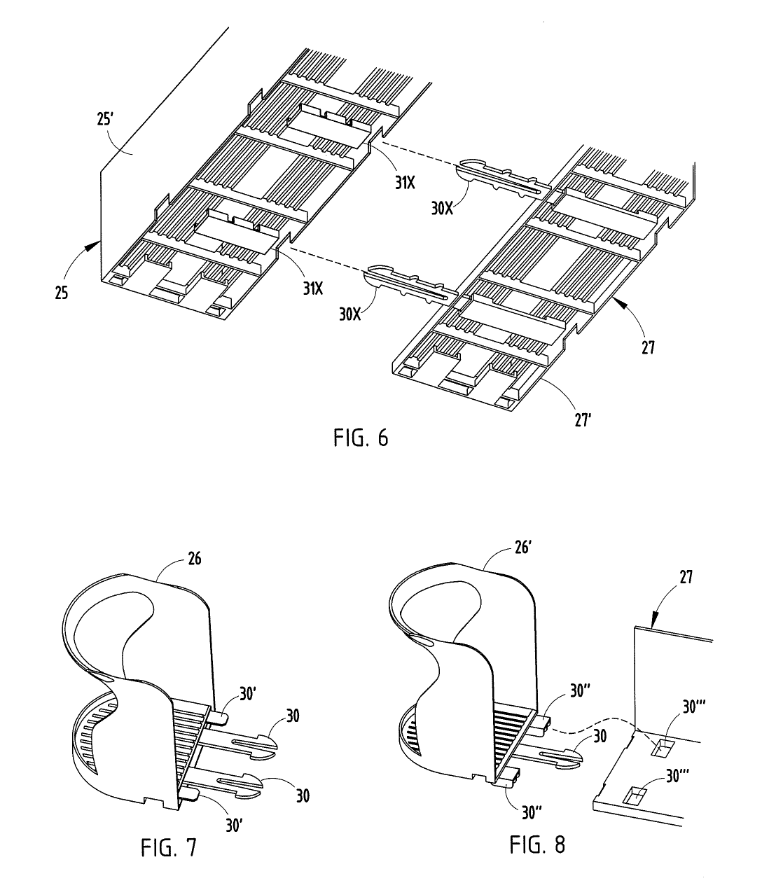

As noted above, the connectors 30 and 31 can be designed to be adjustable, such that a width of the defined paths formed by the adjacent channel-forming elements can be selectively set. For example, it is contemplated that the connectors 30x and/or 31x include multiple barbs or barb-receiving lateral indentations/holes (see FIG. 6) so that the channels can be adjustably interconnected to define a channel having a selected width matching a diameter of the bottle to be displayed/sold. Specifically, by this arrangement, adjacent channel-defining components 25 and 27 can be interconnected to define different width channels/paths, so as to receive a (smaller diameter) soda can, or a (mid-sized) bottle of soda or sport drink, or a (larger-sized) 2-liter pop bottle, or the like. By this arrangement, a given set of components can be selectively assembled to meet different point-of-display-and-sale needs, including the ability to have a same set of components assembled to display different sizes of “for-sale” containers.

Another alternative (not specifically shown) is to place onto the stem of the male connector 30 a spacer (such as a spacer ring or sleeve) that prevents sliding the connectors 30 and 31 to a maximum depth of engagement. In other words, the spacer ring or sleeve would interfere with the L-channel 27 being slid tight against an adjacent L-channel 27 (or adjacent U-channel 25), and further the barbs would only slide to the last-reachable barb-receiving hole. This would cause an increased channel width. The components could be held together by simple mechanical friction. It is contemplated that alternative spacers can also be designed, such as an H-shaped spacer with a first end that engages a floor wall (or vertical wall) of one L-channel 27, and a second end that engages a floor wall of the adjacent L-channel 27.

It is contemplated that the U-shaped channel component 25 can itself be made using an L-shaped channel similar (or identical) to L-channel 27 in combination with an I-shaped wall component (not specifically shown) to for a starter channel. In such apparatus, the channels 27 would be interconnected to each other and the single-wall-defining element would be connected to the last (or first) L-shaped channel 27 to form the plurality of parallel paths. Notably, each of the parallel paths would be formed in part by a shared common wall provided by one of the L-shaped channels.

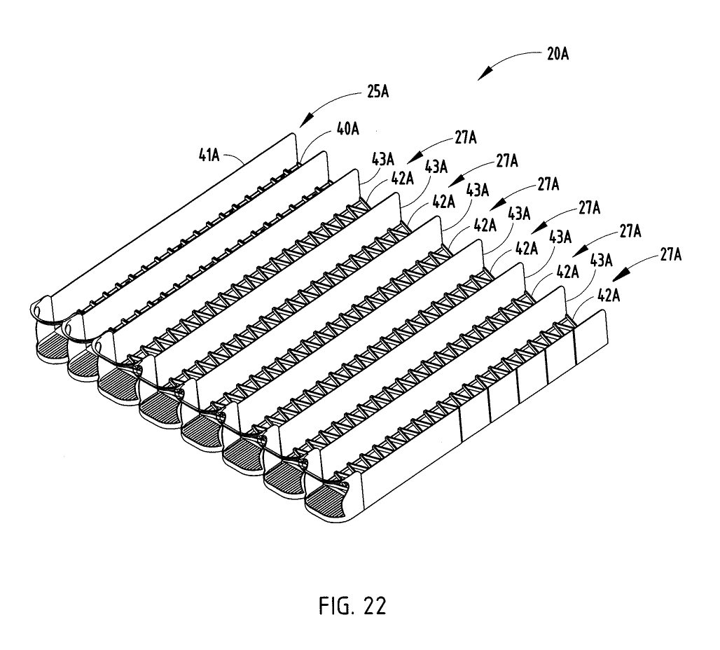

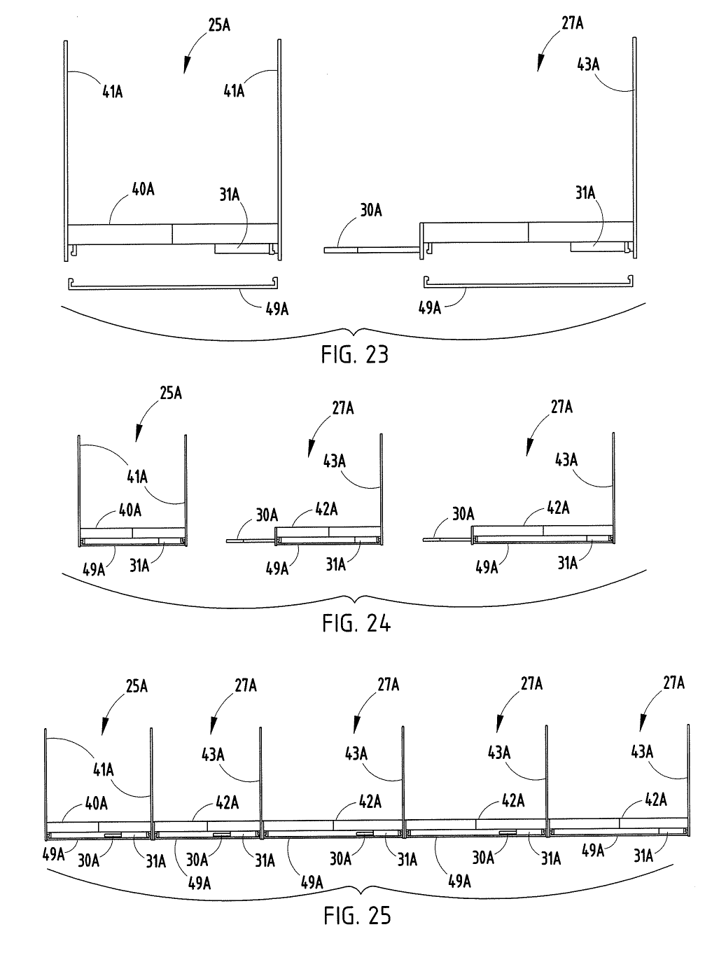

Modified apparatus 20A (FIGS. 21-22) is similar to apparatus 20 (FIG. 1), except apparatus 20A (FIG. 22) includes a U-shaped channel component 25A with an expandable floor section 40A and vertical side wall 41A, and L-shaped extender components 27A with expandable floor section 42A (similar to section 40A) and vertical side wall 43A (similar to side wall 41A). The side walls 41A and 43A may or may not include thinned sections (see thinned sections 35 discussed above) to facilitate selectively manually fracturing and breaking away end portions to leave a channel of selected length.

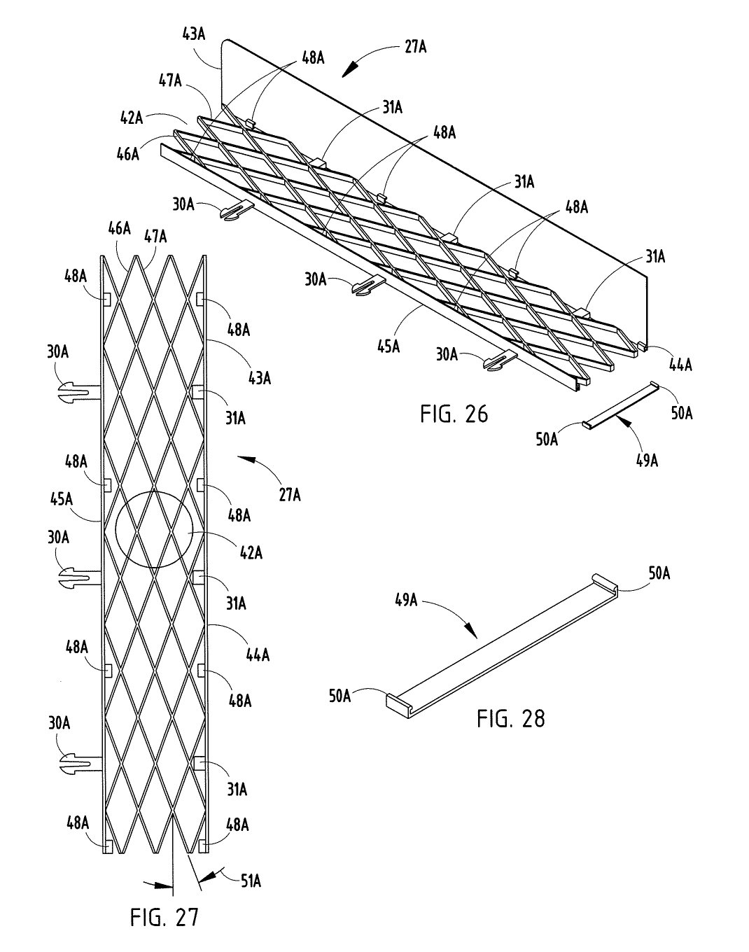

The floor section 42A (FIG. 26) is described hereafter, but it is contemplated that floor section 40A has a similar structure. The floor section 42A includes a pair of parallel outer ribs 44A and 45A of sufficient structure to maintain their linearity, and to support the connectors 30A and 31A, and also to maintain a vertical orientation of the vertical wall 43A. A plurality of crisscrossing diagonal ribs 46A and 47A extend between the ribs 44A and 45A to form a diamond-shaped pattern. It is noted that the longitudinal angle 51A (FIG. 27) of the ribs 44A and 45A should be sufficiently small so that they form a floor upon which supported bottles can (will) slide on longitudinally. This will depend upon a vertical angle of the shelf upon which the apparatus 20A sets (see FIG. 21), and also material lubricity itself, a lubricity of the bottle supported, and other factors. The angle 51A will typically be less than about 45 degrees, and preferably less than about 30 degrees, and most preferably less than about 20 degrees. In an alternative design, it is contemplated that the floor 42A can include longitudinal ribs (not specifically shown) that extend parallel the outer ribs 44A and 45A but that are located at one or more of the apex of points in the diamond-shaped pattern of ribs 46A and 47A. For example, these additional longitudinal ribs could be 4 to 8 in number (or preferably perhaps 4-6 in number) and equally spaced across a width of the (adjusted-width) channel, or alternatively could be equally spaced apart from each other but spaced an increased amount away from the outer ribs 44A and 45A. Further, the additional longitudinal ribs could have a slightly greater vertical dimension than the ribs 44A-47A, such that the supported bottles slide more easily (i.e., the bottles would contact and slide on the additional ribs, and not touch the diagonal ribs).

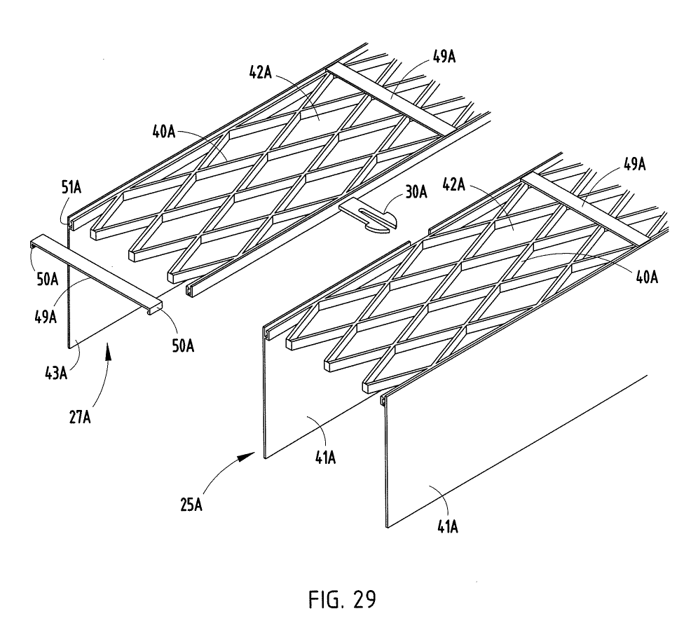

The floor section 42A can be compressed to a desired width, and an angle of the ribs 46A and 47A prevents excessive longitudinal expansion when laterally compressed. The outer ribs 44A and 45A include pockets 48A for receiving clips 49A, the clips 49A having a length (in a channel-width direction) of desired dimension, and having end tabs 50A that extend upwardly to frictionally engaging the pockets 48A. The pockets 48A are spaced longitudinally from the connectors 30A and 31A so that they do not interfere with each other. The end tabs 50A can be linear for a friction fit (with the refrigerator shelf helping hold them in engagement), or can have a hooked tip for biting positive engagement. It is contemplated that the pockets 48A and/or the clips 49A can be replaced with other structure. For example, FIG. 29 shows elongated pockets where the clips (49A) can be engaged with any desired spacing as needed along their length. It is also contemplated that adhesive tape, clamps, clips with rib-grabbing ends, and the like could be used in combination with the front and rear components to hold channel components at a selected desired width dimension.

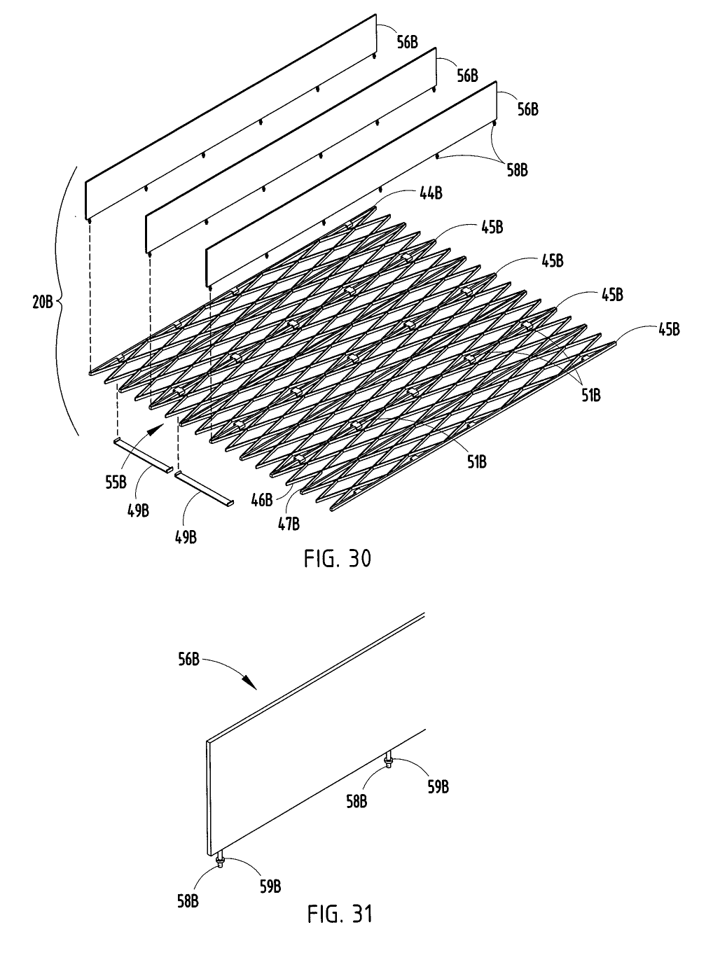

Modified apparatus 20B (FIGS. 30-31) is similar to apparatus 20 (FIG. 1) and apparatus 20A (FIG. 21), except apparatus 20B (FIG. 30) includes a one-piece full floor-forming component 55B that is collapsible (or expandable) in a width direction, and further includes a plurality of identical vertical wall-forming components 56B that attach to the floor-forming component 55B. The floor-forming component 55B includes a plurality of parallel ribs 44B and 45B (e.g. 6 or more as illustrated) and a plurality of crisscrossing diagonal ribs 46B and 47B. The arrangement can be compressed so that the ribs 44B and 45B have a selected width, and then clips 49B would be engaged with the ribs 44B and adjacent rib 45B to hold the selected width. It is contemplated that a single clip could be constructed extending a full width of the floor-forming component 55B if desired, and/or other width-fixing clips/components could be constructed.

The illustrated vertical wall-forming components 56B (FIG. 31) have a plurality of downwardly-extending posts 58B with friction ribs 59B thereon that are configured to frictionally fit into upwardly-open pockets 51B in the longitudinal ribs 44B and 45B of the floor-forming component 55B.

The appearance of the present structures, in addition to having a substantial uniqueness and function(s), are also believed to be novel, ornamental, and unobvious, based on their distinctive appearance, and based on the fact that alternative components can be made for assembly (e.g. see FIGS. 4, 6, 22, 26, 30) and that alternative components can be made compressible/expandable (e.g. see FIGS. 22, 26 and 30).

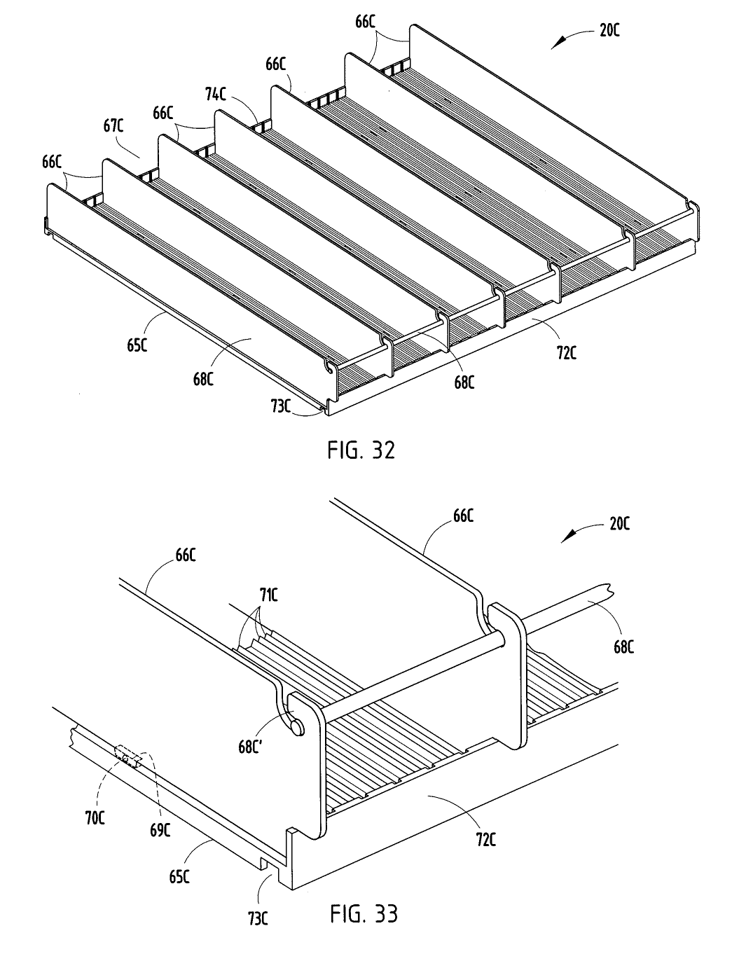

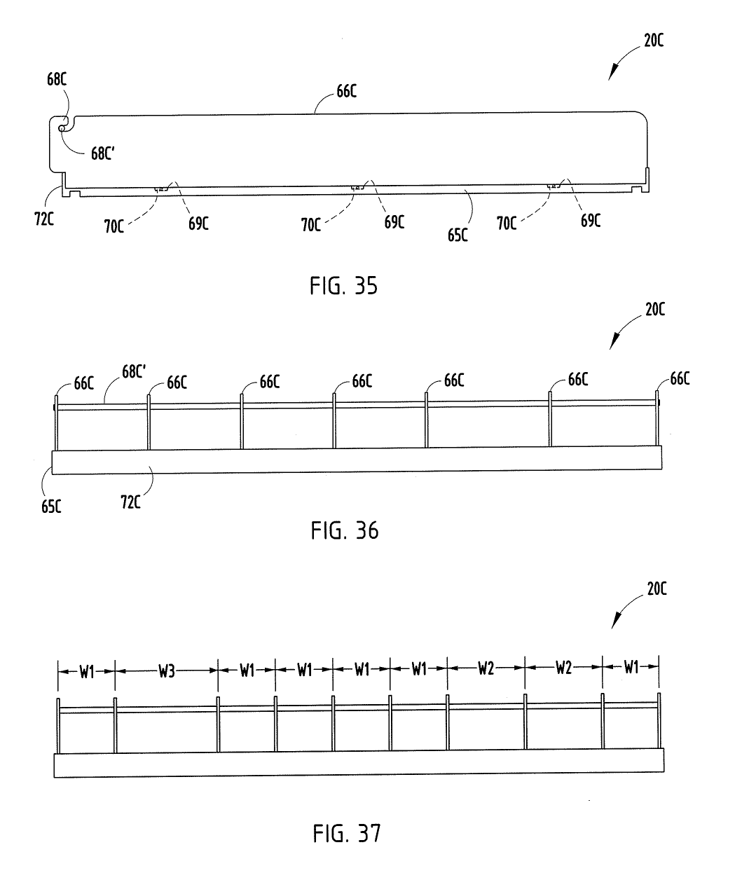

A modified display channel apparatus 20C (FIGS. 32-37) for shelves of a commercial refrigeration unit (see unit 14A in FIG. 21) provides multiple parallel channels/paths for containers to slide forward, thus allowing singular selection from a front of the apparatus 20C. The illustrated apparatus 20C (FIG. 32) is made of polymeric components configured to horizontally snap assemble in a manner forming adjustable width channels.

Specifically, apparatus 20C (FIG. 32) including a floor component 65C and vertical wall-forming components 66C (also called “fence components” herein) that are friction fit into (or snap attached or otherwise secured) to the floor components 65C to form multiple channels 67C for slidably supporting bottles for display and selection from a front thereof. A stabilizer rod 68C is inserted into an L-shaped notch 68C′, which attaches it to a front/top of the fence components 66C. The rod 68C is frictionally retained such that it stabilizes the fence components 66C on the floor component 65C. It is contemplated that another rod could be attached to a rear/top of the fence components 66C if desired. It is noted that the illustrated rod is a metal linear rod of constant diameter, but it is contemplated that other means and materials can be used, such as a stiff plastic rod, a hollow straw, a metal strip, and the like.

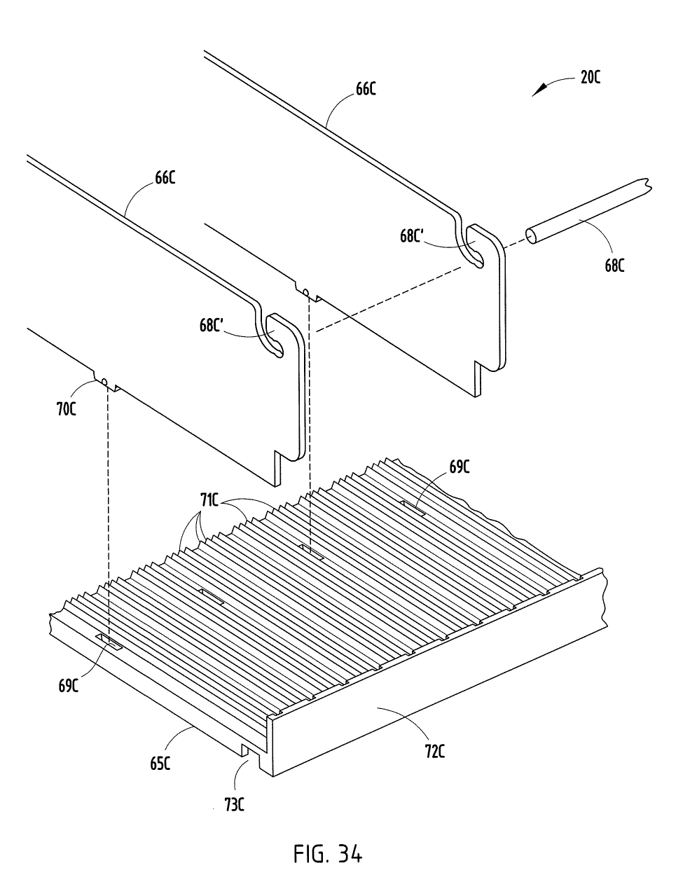

The floor component 65C (FIG. 34) includes a large planar section forming a floor, with rows of short slots/recesses 69C positioned to receive and matingly/snappingly engage protruding legs 70C (also called studs) on the fence components 66C. The floor component 65C further includes a plurality of parallel V ridges or ribs 71C that extend in a front-to-rear direction to facilitate bottles sliding forward thereon. A front up flange 72C is formed to stop forward sliding of the bottles, and is positioned generally under the rod 68C (keeping in mind that the overall apparatus 20C is tilted forward to cause the bottles to slide). Also, a transverse channel 73C is formed under the floor component 65C adjacent the up flange 72C, the purpose being to matably engage a transverse rod in the refrigerator/cooler to hold the apparatus 20C on the shelf of the refrigerator/cooler. A rear up flange 74C is formed at a rear of the floor component 65C, and a transverse channel is formed under the floor similar to the front channel 73C. The up flanges 72C and 74C include vertical grooves for receiving the ends of the fence components 66C for improved stability of the fence components 66C.

The first nine of the fence components 66C of the apparatus 20C illustrated in FIG. 32 are evenly spaced to define channels having a common width. However, notice that the last fence component 66C is spaced more closely, such that a width of the last channel is much narrower. It is contemplated that the recesses 69C can be arranged in a variety of different patterns and width arrangements, including some recesses that are more closely spaced in a width direction than will be used. By doing this, the fence components 66C can be placed at different intervals/spacings. This allows a retail store to arrange (and rearrange) the fence components 66C to define an optimal set of channel widths. For example, FIG. 36 shows an apparatus 20C where the channels define four different widths W1-W3.

There are many advantages provided by the present apparatus 20C. Assembly is extremely simple and intuitive. Assembly allows the store to adjust channel widths to a selected optimal set of widths and positions. Disassembly is also easy, and allows for reconfiguration and re-use, as well as allows for total separation of dissimilar components for optimal recycling and “green” environmentally-friendly disposal. Each of the components 65C, 66C, 68C are simple non-complex components. Components 65C and 66C can be molded with relatively simple tooling, since they do not require undercuts. Hence, they do not require slides nor pulls in the tooling for injection molding. Further, common parts can be used. It is noted that the fence components can include a breakaway groove(s) if desired (see thinned sections 35 in FIGS. 11-13).

It is to be understood that variations and modifications can be made on the aforementioned structure without departing from the concepts of the present invention, and further it is to be understood that such concepts are intended to be covered by the following claims unless these claims by their language expressly state otherwise.

The embodiments of the invention in which an exclusive property or privilege is claimed are defined as follows:

1. A display channel apparatus for slidingly supporting rows of individual containers for purchase from a front of each row, comprising:
an elongated starter channel component;
a plurality of elongated extender channel components each including horizontally-oriented connectors constructed for quick-connect in a horizontal direction to a side of a selected one of the starter channel and the extender channels, and that when connected, define multiple parallel channels each of desired width generally matching a width dimension of the individual containers; and
a plurality of front components configured for attachment to a front of one or both of the starter channel and extender channels.

2. The display channel apparatus defined in claim 1, wherein the starter channel component and the extender channel components each include a plurality of integrally formed mating connectors.

3. The display channel apparatus defined in claim 2, wherein the starter channel component and the extender channel components include a plurality of first male connectors and a plurality of first female connectors for mating horizontal connection.

4. The display channel apparatus defined in claim 3, wherein the starter channel component defines a U-shape forming both sides of a first path for containers.

5. The display channel apparatus defined in claim 3, wherein the extender channel component defines an L-shape forming one side of a second path for containers.

6. The display channel apparatus defined in claim 1, including a plurality of rear components with connectors configured for quick connect to one of the starter channel component and the extender channel components.

7. The display channel apparatus defined in claim 1, wherein the starter channel component and the extender components each include at least one sidewall with a vertically-extending weakened line, and wherein each is made of material that fractures upon bending, so that upon manual bending, an end piece can be readily broken off and removed.

8. The display channel apparatus defined in claim 1, wherein at least one of the channel components and the extender components are shaped to matingly interfittingly engage identical parts for dense storage when inverted and interfit together, the dense storage resulting in an increased density by at least 40% versus when the extender components are placed adjacently in non-interfitting engagement.

9. The display channel apparatus defined in claim 8, wherein the channel component and the extender components, when interconnected to form an assembly, can be inverted and interfit against an identical assembly for dense storage of at least 40% increased density over non-interfitting engagement.

10. The display channel apparatus defined in claim 8, wherein the channel-forming components can be interfit prior to being finally assembled together to form the multiple channels and to increase a ship density by at least 70%.

11. The display channel apparatus defined in claim 1, wherein at least one of the channel component and the extender components is adjustable in a lateral direction to define a width-adjustable channel that can be adjusted to have a first width or a second width, and including a width-fixing component for fixing the width-adjustable channel to a desired one of the first width and the second width.

12. A display channel apparatus for slidingly supporting rows of individual containers for purchase from a front of each row, the individual containers defining at least first and second different widths dimesions, comprising:
a plurality of channel-forming components including mating connectors that can be interlockingly connected to position and secure the channel-forming components adjacently, at least one of the connectors and the channel-forming components being adjustable to define at least the first and second different width dimensions.

13. A display channel apparatus for containers, comprising:
a wall-defining starter component; and
a plurality of L-shaped channel components interconnected to each other and to the wall-defining component to form a plurality of parallel paths, the parallel paths each sharing a common wall provided by one of the starter component and the L-shaped channel components.

14. A display channel apparatus for supporting sliding rows of individual containers for purchase from a front of each row, comprising:
an adjustable-width floor component;
a plurality of vertical-wall-forming components attached to the floor component at selected parallel spaces to define a plurality of upwardly-open parallel channels thereon; and
a plurality of width-fixing components fixing the adjustable-width floor component to a desired adjusted width for each of the channels, so that the channels each match a width of the selected individual containers in each row.

15. A display channel apparatus for supporting sliding rows of individual containers for purchase from a front of each row, comprising:
a floor component constructed to slidably support the containers and having first connectors at multiple locations; and
a plurality of vertical wall-forming components with second connectors attached to selected ones of the first connectors to define a plurality of parallel rows for slidably supporting product thereon, the rows having selected width dimensions.

16. The display channel apparatus defined in claim 15, wherein the floor component includes front and rear up flanges with structures configured to engage front and rear ends of the wall-forming components.

17. The display channel apparatus defined in claim 15, including a transverse elongated member engaging a top of each of the wall-forming components to stabilize a vertical orientation of same.

18. The display channel apparatus defined in claim 15, wherein the first connectors include recesses, and wherein the second connectors frictionally engage the first connectors.

19. The display channel apparatus defined in claim 15, wherein the floor component includes groups of the first connectors being aligned in a direction parallel the rows and each of the groups being spaced across the floor component to define different width locations, and wherein the wall-forming components are attached to selected ones of the groups of first connectors so that the rows each have a desired width, with at least one of the rows having a different width than an adjacent one of the rows.

20. A method of assembling a display channel apparatus for containers, comprising steps of:
providing a plurality of channel-forming components including integrally-formed mating connectors; and
interlockingly assembling the channel-forming components by friction attachment to define channels of selected widths.
